(19) United States
(12) Patent Application Publication
(10) Pub. No.: US 2026/0329603 A1
(43) Pub. Date: Oct. 22, 2026

(54) System and Method for Overlaying One or More Applications

(71) Applicant: Transformate, LLC, New York, NY (US)

(72) Inventors: Benjamin Leader, Jamestown, RI (US); Yashendra Kumar, New York, NY (US)

(21) Appl. No.: 19/724,003

(22) Filed: Jun. 29, 2026

Related U.S. Application Data
(63) Continuation of application No. 18/485,258, filed on Oct. 11, 2023.
(60) Provisional application No. 63/415,181, filed on Oct. 11, 2022.

(51) Int. Cl. G06F 9/451; G06F 9/54

(52) U.S. Cl. CPC G06F 9/451; G06F 9/543

(57) ABSTRACT

The present disclosure relates to an apparatus and method for overlaying one or more applications A computer-implemented method that includes: first allowing a user in one application to open and control a layout of both a web application and a desktop application, then allowing the web application and the desktop application to load and run in a native state. The method continues by allowing the user to direct which records are loaded by the web application and the desktop application, and ultimately allows the user to control a window position/layout of both the web application and the desktop application.

### RELATED APPLICATIONS

This application is a continuation of U.S. Patent Application No. 18/485,258 filed Oct. 11, 2023, which claims the benefit of U.S. Provisional Application No. 63/415,181, filed on Oct. 11, 2022, the entire contents of which is herein incorporated by reference.

### TECHNICAL FIELD

This disclosure relates to systems and methods for overlaying one or more applications in a single shell program.

### BACKGROUND

Overlaying applications is a feature that allows apps to appear on top of other apps. For example, some messaging apps may cause a chat bubble to appear in front of an open app, such as a browser.

Constructing an overlay program involves manually dividing a program into self-contained object code blocks called overlays or links, generally laid out in a tree structure. Sibling segments, those at the same depth level, share the same memory, called overlay region or destination region. An overlay manager, either part of the operating system or part of the overlay program, loads the required overlay from external memory into its destination region when it is needed; this may be automatic or via explicit code. Often linkers provide support for overlays.

### SUMMARY OF DISCLOSURE

A computer-implemented method comprising: allowing a user in one application to open and control a layout of both a web application and a desktop application; allowing the web application and the desktop application to load and run in a native state; allowing the user to direct which records are loaded by the web application and the desktop application; and allowing the user to control a window position and layout of both the web application and the desktop application.

The computer-implemented method, further comprising: allowing a user to select one or more graphical analytic features and configure automatic extraction of record data into a grid; and automatically opening records in multiple different targeted applications. displaying graphical analytics at a graphical user interface; and allowing a data source to be changed in real-time from a program data grid to any other table/database/source. wherein hovering a cursor over a section of a first graphical representation of data provides more detailed information about that section of the first graphical representation. wherein right clicking a grid of patient data allows for the grid of patient data to be filtered based on pre-defined data categories. wherein the pre-defined data categories are user-defined. wherein checking an “Apply to Dash” checkbox updates the first graphical representation to show a second graphical representation of the filtered data. wherein both the web application and desktop application include a modular overlay ticketing system (MOTS) configured to create a ticket which automatically extracts from a source of patient record information. wherein the MOTS includes a ticket template button configured to open a template selection screen. wherein the template selection screen includes a ticket creation button configured to open a ticket manager window and allow for user creation of a new ticket that is automatically associated with a pre-loaded record for a selected patient. wherein the ticket manager window is configured to open an external desktop application in a multi-overlay window.

A computer-readable storage medium having stored thereon instructions, which when executed by a processor result in the following operations: allowing a user in one application to open and control a layout of both a web application and a desktop application; allowing the web application and the desktop application to load and run in a native state; allowing the user to direct which records are loaded by the web application and the desktop application; and allowing the user to control a window position/layout of both the web application and the desktop application.

The computer-readable storage medium, wherein further instructions, to be executed by the processor result in the following operations: allowing a user to select one or more graphical analytic features and configure automatic extraction of record data into a grid; and automatically opening records in multiple different targeted applications. , wherein further instructions, to be executed by the processor result in the following operations: displaying graphical analytics at a graphical user interface; and allowing a data source to be changed in real time from a program data grid to any other table/database/source. wherein hovering a cursor over a section of a first graphical representation of data provides more detailed information about that section of the first graphical representation. wherein right clicking a grid of patient data allows for the grid of patient data to be filtered based on pre-defined data categories. wherein the pre-defined data categories are user defined. wherein checking an “Apply to Dash” checkbox updates the first graphical representation to show a second graphical representation of the filtered data.

wherein both the web application and desktop application include a modular overlay ticketing system (MOTS) configured to create a ticket which automatically extracts from a source of patient record information. wherein the MOTS includes a ticket template button configured to open a template selection screen.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts one or more processes coupled to a distributed computing network;

FIG. 2 is an exemplary flowchart of a process according to an embodiment of the present disclosure;

FIG. 3A shows an example home screen in a shell program according to embodiments of the present disclosure;

FIG. 3B shows an example overlay program in a graphical user interface (GUI) according to embodiments of the present disclosure;

FIG. 4 shows an example overlay program in use loading electronic medical records (EMR) in a GUI according to embodiments of the present disclosure;

FIG. 5 shows an example patient billing page in a GUI according to embodiments of the present disclosure;

FIG. 6A shows an example analytic feature in a GUI according to embodiments of the present disclosure;

FIG. 6B shows an example analytic feature in use performing data extraction in a GUI according to embodiments of the present disclosure;

FIG. 6C shows an example of EMR patient data extracted in a GUI according to embodiments of the present disclosure;

FIG. 6D shows an example of a selected patient’s information in a GUI according to embodiments of the present disclosure;

FIG. 6E an example EMR for a selected patient of interest opened in a web app information in a GUI according to embodiments of the present disclosure;

FIG. 7A shows an example multi-window view of an overlay program in a GUI according to embodiments of the present disclosure;

FIG. 7B shows an example of filtered data records in a multi-window view in a GUI according to embodiments of the present disclosure;

FIG. 7C shows an example graphical representation of the filtered data records in a multi-window view in a GUI according to embodiments of the present disclosure;

FIG. 8A shows an example patient information page in a modular overlay ticket system (MOTS) in a GUI according to embodiments of the present disclosure;

FIG. 8B shows an example of a MOTS ticket template selection screen in a GUI according to embodiments of the present disclosure;

FIG. 8C shows an example of a MOTS ticket manager window in a GUI according to embodiments of the present disclosure; and

FIG. 8D shows an example of an external application in a multi-window view in a GUI according to embodiments of the present disclosure.

### DETAILED DESCRIPTION

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. In the drawings, the thicknesses of layers and regions may be exaggerated for clarity. Like reference numerals in the drawings denote like elements.

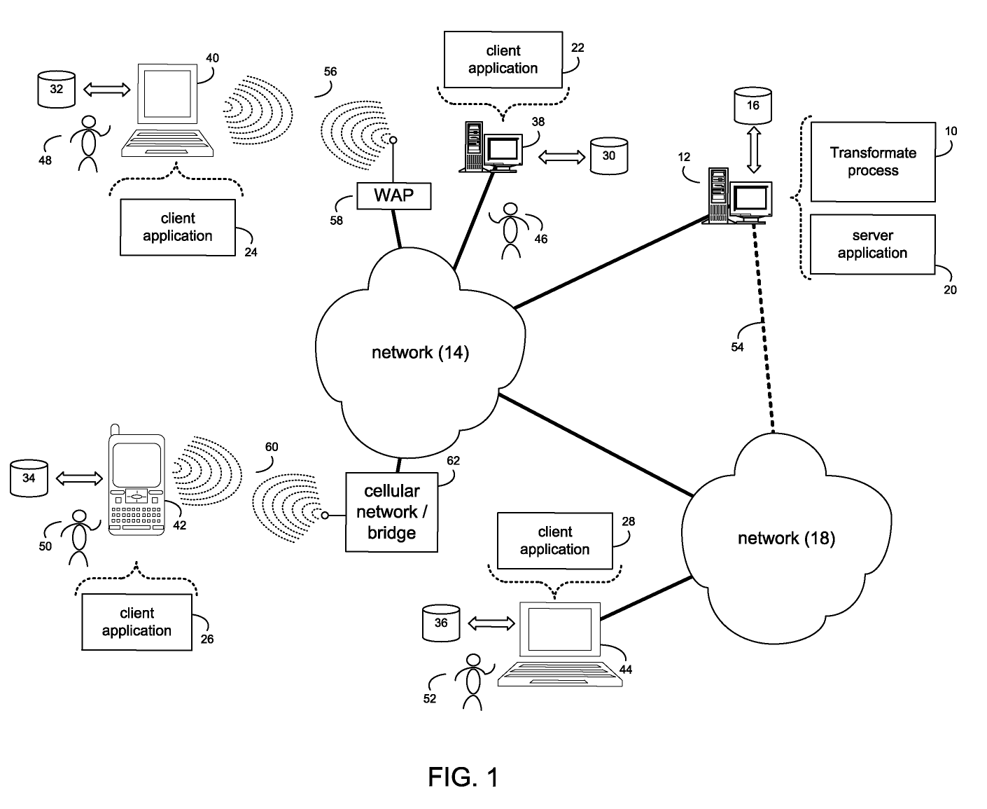

Referring to FIG. 1, there is shown process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server^{tm}; Novell Netware^{tm}; or Redhat Linux^{tm}, for example. Additionally and/or alternatively, the process may reside on a client electronic device, such as a personal computer, notebook computer, personal digital

The instruction sets and subroutines of process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS ^{tm}, Novell Webserver ^{tm}, or Apache Webserver ^{tm}, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Lotus Domino^{tm} Server and Microsoft Exchange^{tm} Server. Server application 20 may interact with one or more client applications (e.g., client applications 22, 24, 26, 28) in order to execute process 10. Examples of client applications 22, 24, 26, 28 may include, but are not limited to, design verification tools such as those available from the assignee of the present disclosure. These applications may also be executed by server computer 12. In some embodiments, process 10 may be a stand-alone application that interfaces with server application 20 or may be an applet / application that is executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition / as an alternative to being a server-based application residing on server computer 12, the process may be a client-side application (not shown) residing on one or more client electronic devices 38, 40, 42, 44 (e.g., stored on storage devices 30, 32, 34, 36, respectively). As such, the process may be a stand-alone application that interfaces with a client application (e.g., client applications 22, 24, 26, 28), or may be an applet / application that is executed within a client application. As such, the process may be a client-side process, a server-side process, or a hybrid client-side / server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize formal analysis, testbench simulation, and/or hybrid technology features verify a particular integrated circuit design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network / bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows ^{tm}, Microsoft Windows CE ^{tm}, Redhat Linux ^{tm}, Apple iOS, ANDROID, or a custom operating system.

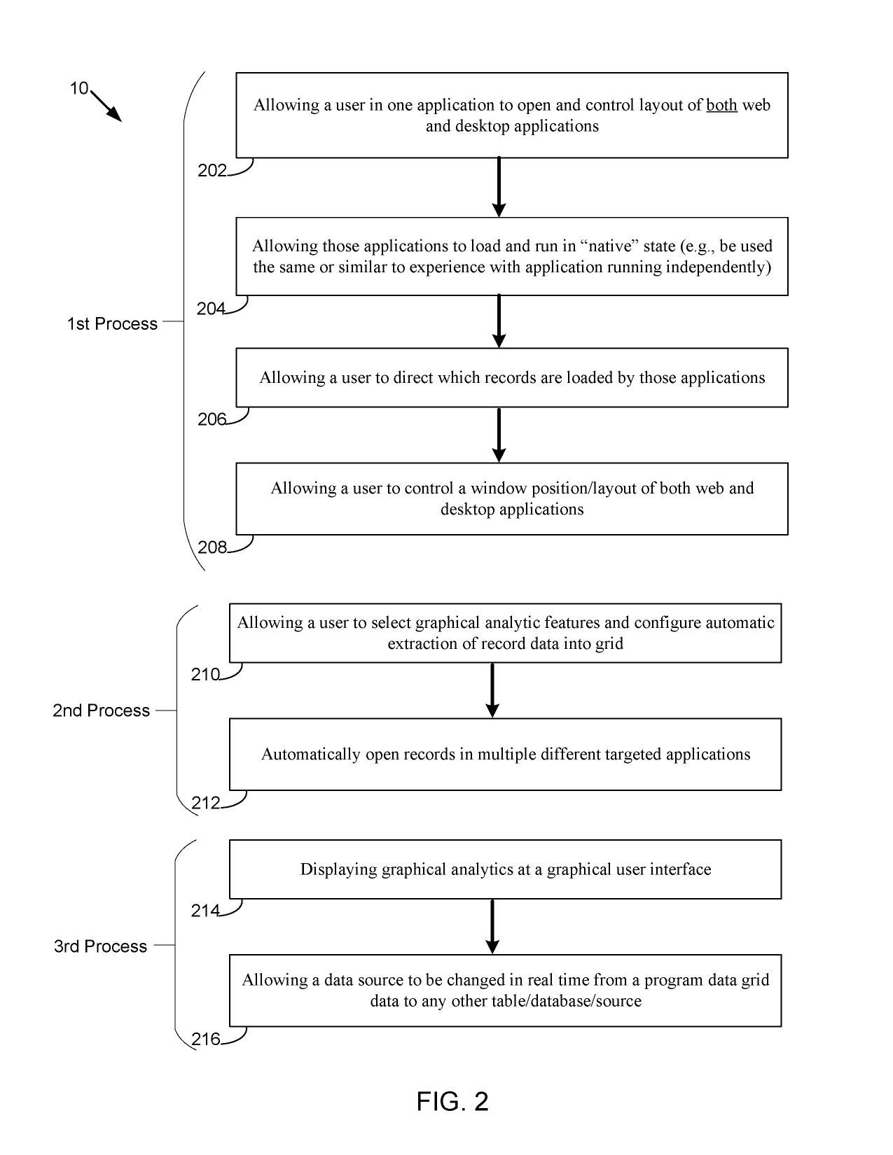

Referring now to FIG. 2, a flowchart depicting embodiments consistent with process 10 (which may include one or more processes or sub-processes such as a first process, second process, third process, etc.) is provided. A first process may include allowing (202) a user in one application to open and control the layout of both web and desktop applications. The process may further include allowing (204) those applications to load and run in a “native” state (e.g., be used the same or similar to experience with application running independently). The process may also include allowing (206) a user to direct which records are loaded by those applications and allowing (208) a user to control a window position/layout of both web and desktop applications. A second process may include allowing (210) a user to select graphical analytic features and configure automatic extraction of record data into a grid and automatically opening (212) records in multiple different targeted applications (e.g. within the overlay). The third process may include displaying (214) graphical analytics at a graphical user interface and allowing (216) a data source to be changed in real time from a program data grid data to any other table/database/source. Numerous other operations are also within the scope of the present disclosure as discussed hereinbelow.

In some embodiments, the processes provided herein may include an “Overlay” application, which may be configured within a program shell to host and interact with both Web and Desktop Applications. Embodiments of the present disclosure may include a software application, which may be referred to herein as BLIS^{TM}. A key feature may be the ability for BLIS to overlay upon both web and desktop application, providing the user with one or more software applications which may be hosted by, and may interact with, a common shell. Within the common shell, the applications may function as they would normally, e.g., as if the user were to work with them in their native or normal state. Within BLIS, the user may coordinate record loading and interaction amongst multiple desktop and web applications simultaneously. The graphical user interface (GUI) of BLIS may be designed to allow users to perform standard functions or operations including, but not limited to, searching, viewing, and/or editing records quickly.

In some embodiments, the processes provided herein may include multiple components including, but not limited to, BLIS Windows (.net) application shell and a BLIS web application shell. The BLIS Windows (.net) application shell may enable BLIS to create one or more instances and/or run any .net windows application. The BLIS Windows (.net) application shell may also enable the user to interact with a running window application GUI to perform actions including, but not limited to, user login, performing a search for a record, loading a record, etc. The BLIS Web application shell may enable BLIS to load and run any web application within the shell. The BLIS Web application shell may also enable BLIS to interact with a running web application GUI to perform actions including, but not limited to, user login, performing a search for a record, loading a record, etc.

In some embodiments, a BLIS Overlay application may be created with one Windows Desktop application and one Web application by using a computer with the one or more of following elements: Microsoft Windows 10 OS, .Net framework 4.7.2, and Microsoft Visual Studio IDE (2019). These examples are provided merely by way of example as other versions, operating systems, development frameworks and integrated development environments may be used without departing from the scope of the present disclosure. In operation, various operations may be employed to create shells and overlay.

For example, creating a BLIS Windows (.net) application shell may include, but is not limited to, one or more of the following operations. A first operation may include creating a project “BLIS Windows Shell” with a form. A second operation may include calling a System.Reflection Namespace located Assembly Class “CreateInstance” method with all necessary parameters to load a targeted .exe/.dll located form; upon successful form instance creation of targeted form. A third operation may include adding this form to a control collection of forms created in first step and call Show method of this form. A fourth operation may include, to enable BLIS application integration, creating a mapping of targeted controls where these controls and their corresponding map may be required to access these controls to perform actions as workflow required use Reflection to access property, method, and event to pull – push data and trigger one or more events.

By way of further example, creating a BLIS Web application shell may include, but is not limited to, one or more of the following operations. A first operation may include creating a project “BLIS Web App Shell” with a form. A second operation may include creating CefSharp browser instance with app URL. A third operation may include add the CefSharp browser instance to the form created in the first step. A fourth operation may include finding GUI elements by ID. A fifth operation may include performing an action by executing a JavaScript to perform an action on a targeted GUI element to pull – push data and trigger one or more events.

By way of further example, creating a BLIS overlay may include, but is not limited to, one or more of the following operations. A first operation may include create a project “BLIS Overlay ” with a form. A second operation may include adding one or more references of “BLIS Windows Shell” and a “BLIS Web App Shell” projects to the project. A third operation may include, in the form, adding a grid to host corresponding data of interest and ensuring that this data has all required details to load respective windows and web applications and their records. A fourth operation may include adding a tab control with two tab pages in the form including in first tab, adding “BLIS Windows Shell,” and in a second tab, adding “BLIS Web App Shell.” A fifth operation may include filling in details to load a windows application in the “BLIS Windows Shell” and a web application in the “BLIS Web App Shell.” A sixth operation may include, on a form of the BLIS Overlay, loading an event to perform one or more login steps in both applications. A seventh operation may include, on a grid row change, taking program name and unique IDs of a corresponding focused record from the grid, passing the program name and unique IDs to both applications, and loading the program with corresponding records.

In some embodiments, the processes provided herein may include an application Embedded Graphical Analytics Driving Application Record Interaction. This may allow a user to select graphical analytic features, configure automatic extraction of record data into a grid, and automatically open records in multiple different targeted applications.

In some embodiments, the application embedded graphical analytics may include multiple components, including, but not limited to, an Entity Grid, Dashboard Viewer and BLIS Shells. The Entity Grid may include a custom grid control enables program to receive a list of records to load as a dataset The Dashboard Viewer may include a dashboard control, with a custom BLIS layer to extract datasets from dashboard. The BLIS shell may be configured to load various applications in overlays.

In some embodiments, the process may utilize a computing device having Microsoft windows 10 OS, a .Net framework 4.7.2, a Microsoft Visual Studio IDE (2019), and DevExpress Controls. In operation, this may be generated by creating a windows form with an Entity control, a BLIS Shell, and a Dashboard Viewer. In the Dashboard Viewer, a method to extract a corresponding dataset may be added. In the form, a method for a grid to receive lists of records to filter and load only a received records list may be created. On the Dashboard Viewer click event, an extracted dataset may be passed to a new instance of the form. This extracted dataset may be used by a newly launched instance of the form which may pull DB records and load them in a Grid. These grid records may load other application programs in the BLIS shells as configured.

In some embodiments, the processes provided herein may include embedded graphical analytics interchangeable in real time from a program data grid to any other table/database/source. Programs may currently either focus embedded graphical analytics on a specific program grid or have standard data sources such as database tables, but a graphical data source may not be changed real time. Graphical analytics may include multiple components, namely an Entity Grid and a Dashboard Viewer. The Entity Grid may include a custom grid control with user friendly filters that allows users to get to a targeted dataset quickly. The Dashboard Viewer may include a Devexpress provided dashboard control, with a custom BLIS layer to accept a grid available dataset as input to build a dashboard. This may allow a user to visualize grid data into dashboards and enable options to dig deeper into a dashboard for meaningful insights.

In some embodiments, a computing device having Microsoft Windows 10 OS, .Net framework 4.7.2, Microsoft Visual Studio IDE (2019), and DevExpress Controls may be provided. Generating may include creating a windows form with an Entity control and Dashboard Viewer. In the Dashboard Viewer, a method to enable a dashboard to receive an incoming dataset from an Entity Grid Control may be added. Further, a check box in the Entity Grid Control to push the dataset to the Dashboard Viewer may be added. Also, a method in the Entity Grid control to push data to the Dashboard viewer on any filter applied event may be added.

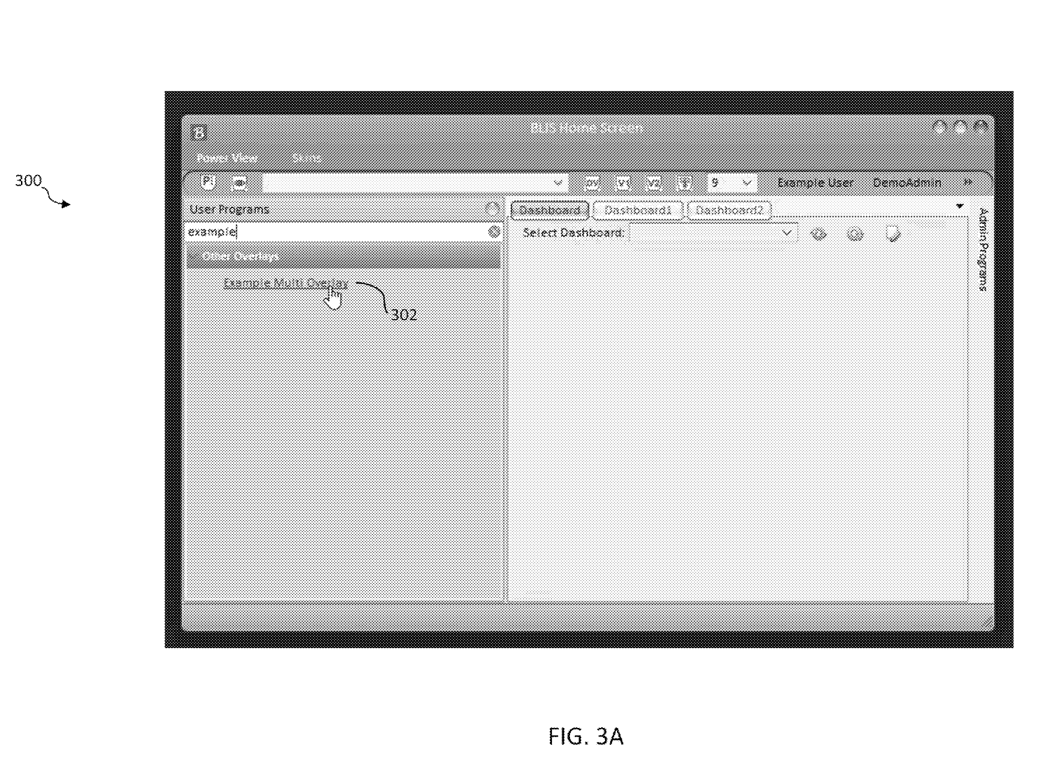

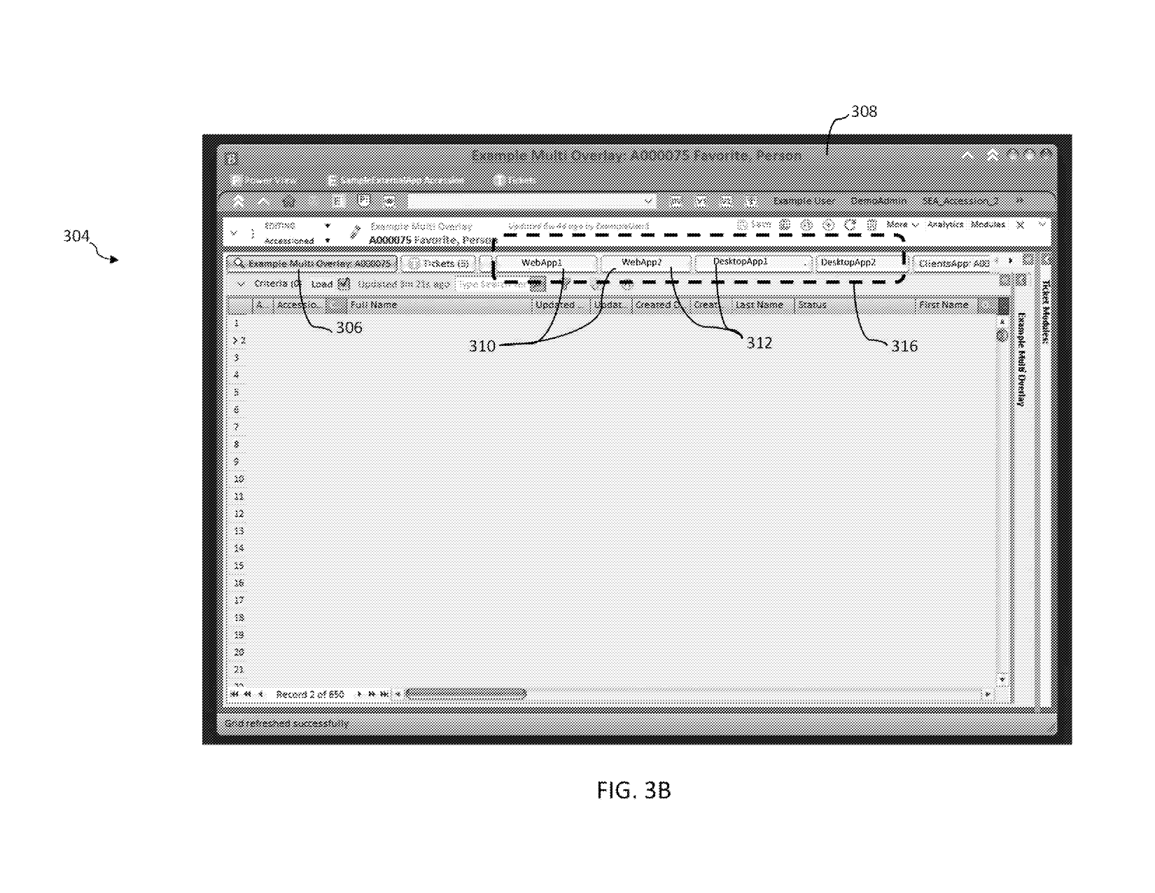

Referring to FIGS. 3A-5, embodiments depicting graphical user interfaces 300, 304, 400, and 500 consistent with embodiments of the present disclosure are provided. These figures may depict an overlay application 306 which may be able, from within a program shell 308, to host and interact with both web applications 310 and desktop applications 312. In operation, a user may be able, in one application, to open and control the layout of both web and desktop applications 312, 314. The user may be able to have those applications load and run in “native” state (e.g., be used the same or similar to experience with application running independently). The user may be able to direct which records are loaded by those applications. The user may also be able to control window position/layout of both web and desktop applications 312, 314.

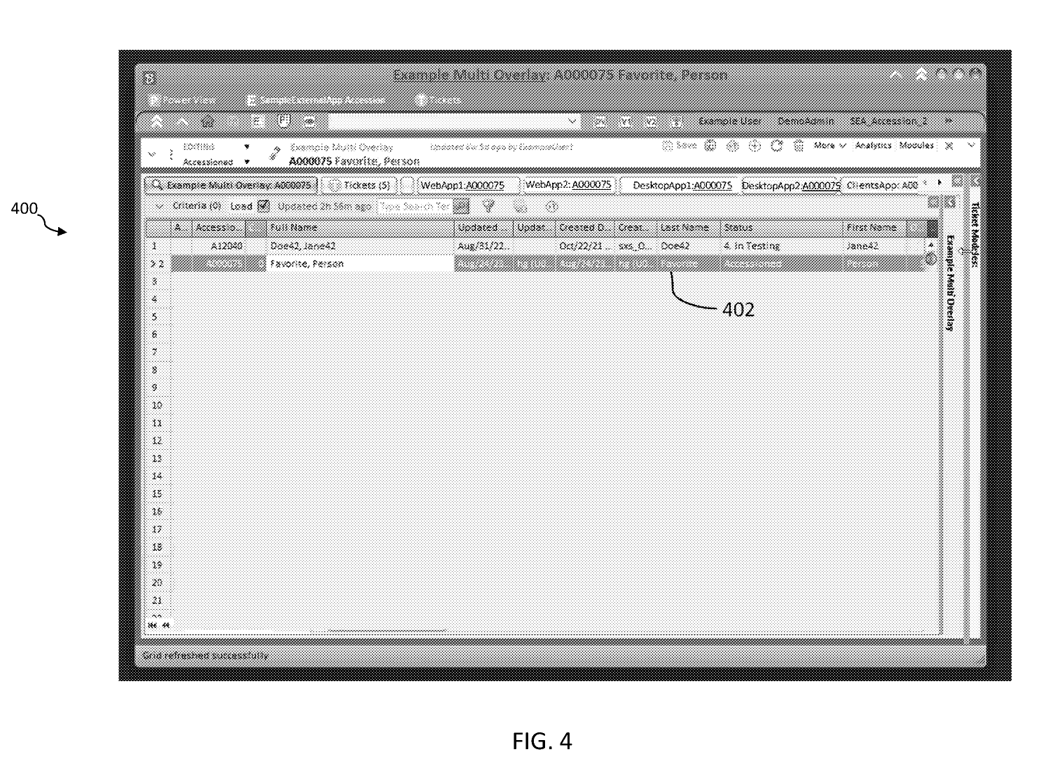

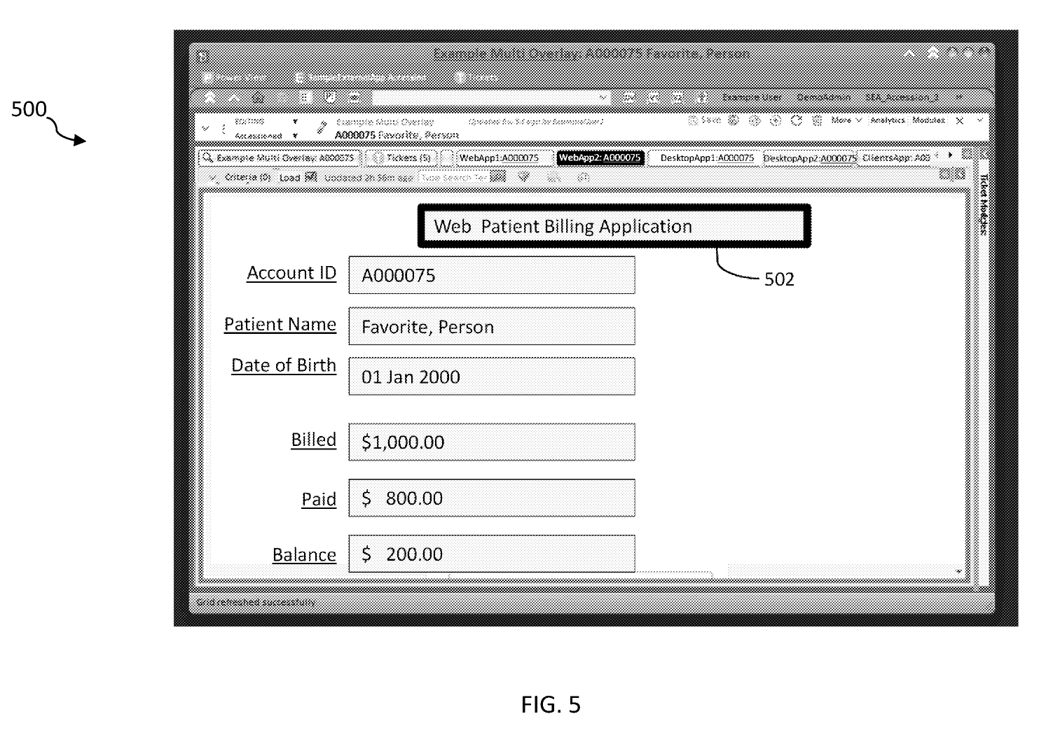

In one embodiment, as shown in FIG. 3B, the user may be able to load, within one shell program window 316, multiple tabs with web applications 312 and tabs with desktop applications 314. For example, the software user may be a healthcare worker managing patients which have medical records in a desktop application 314 showing electronic medical records (EMR) as shown by overlay 400 in FIG. 4, but also show billing records 502 in a web application 312 ) as shown by overlay 500 in FIG. 5. The healthcare worker can have both the desktop EMR and billing web applications launched in the same program shell and use each application (desktop and/or web) in their normal state.

Applications may launch automatically and log a user in. These applications may be used with their normal functionality. The user may switch easily between applications and control their window size. For example, a user may click on a tab for a desktop application 314 under the common shell 316 and the program would show a launched desktop application 314 (like a patient EMR) program 402 as shown in FIG. 4), working in normal state. Similarly, a user could click on a tab for a web application 312 under the common shell 316 and the program would show a launched web application (like a patient billing program 502 shown in FIG. 5) working in normal state. Effectively, the healthcare worker can view a list of patients and have both the EMR desktop app 314 and the billing web app 312 launched in the same shell program 316 with the patient record automatically loaded in both applications.

In another embodiment, a graphical user interface 400 may allow a user to have a grid of records 402 on which the user can click to cause one or more records to load in either or both web applications 312 and desktop applications 314.

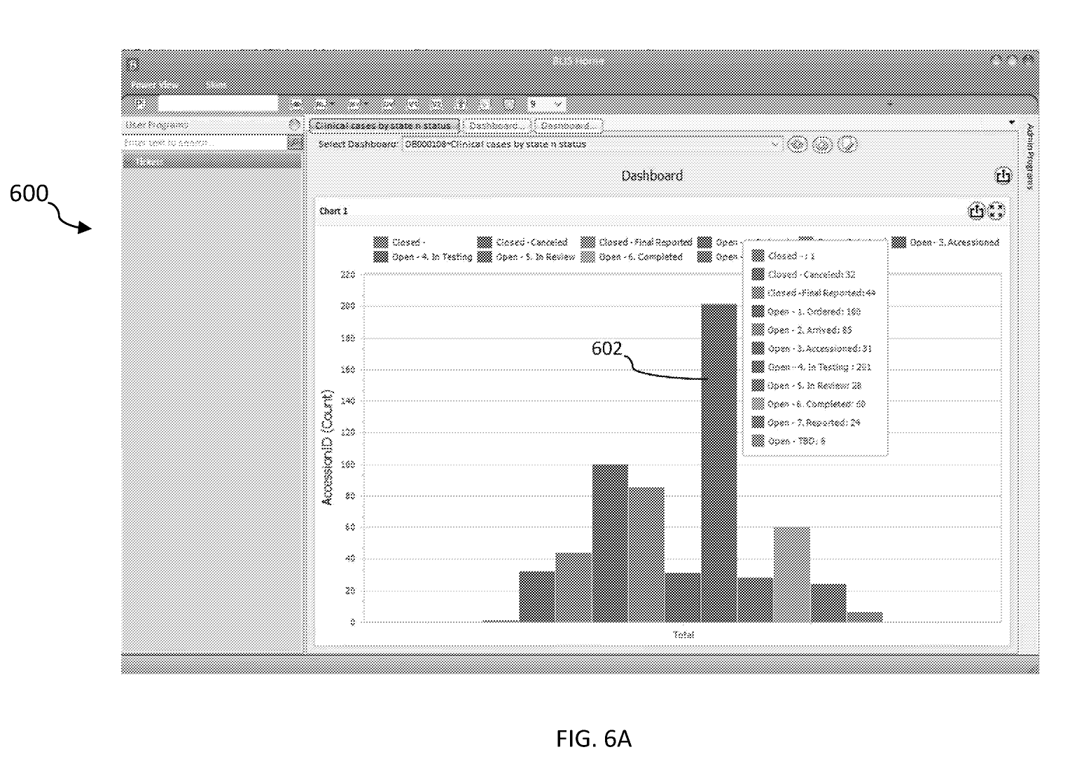

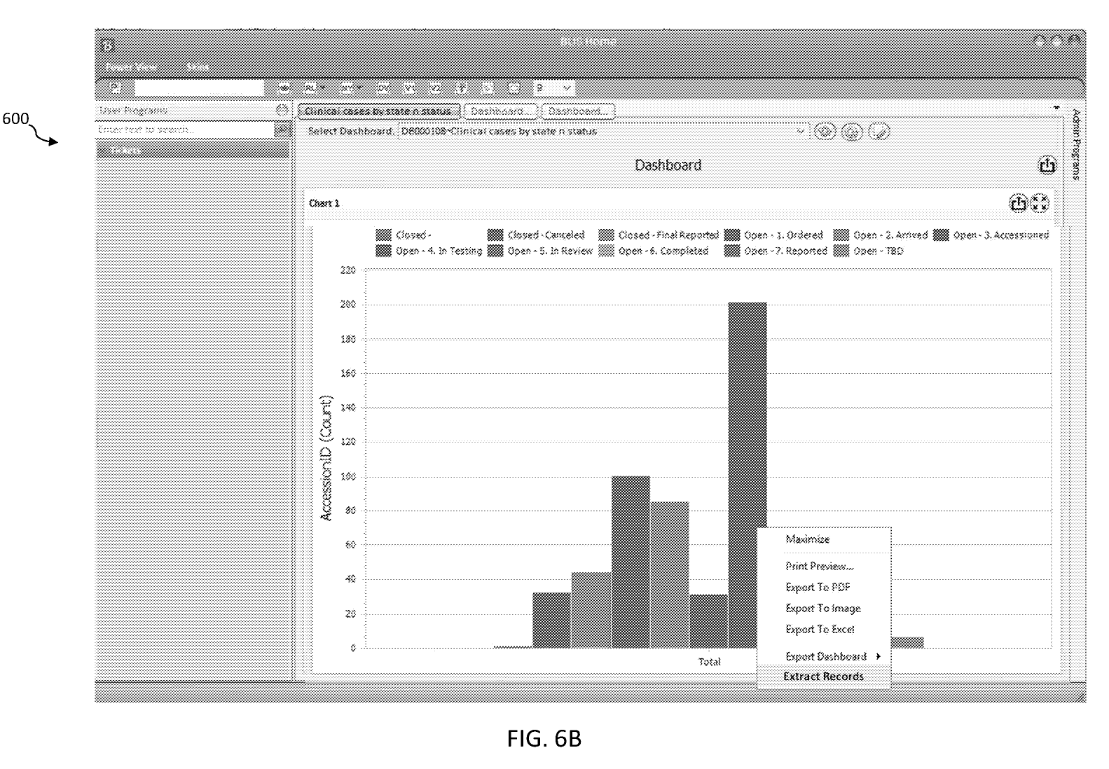

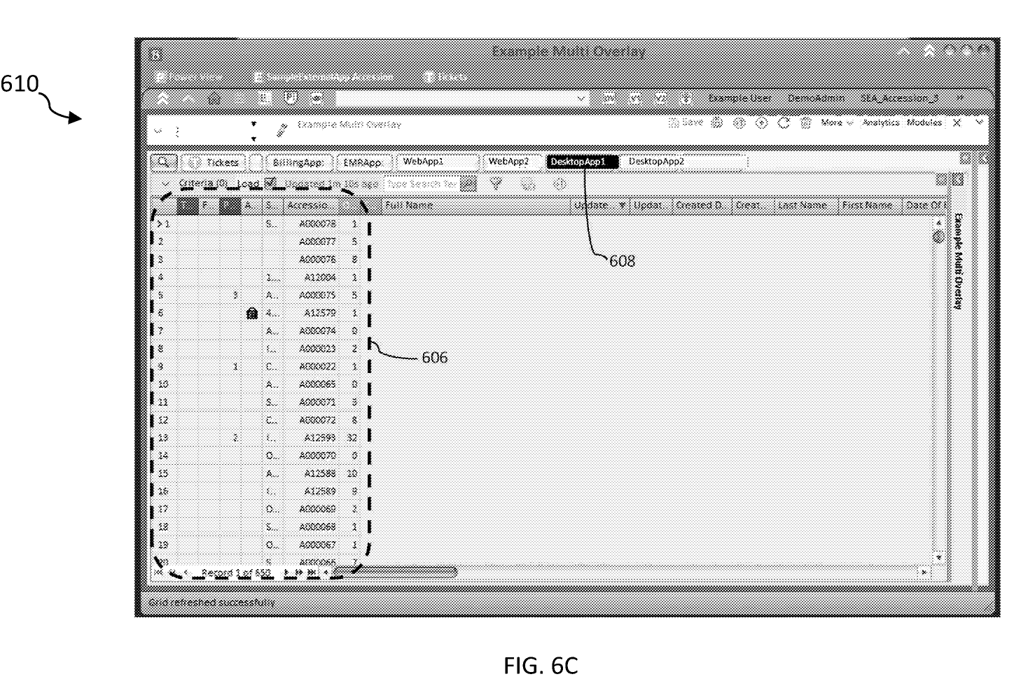

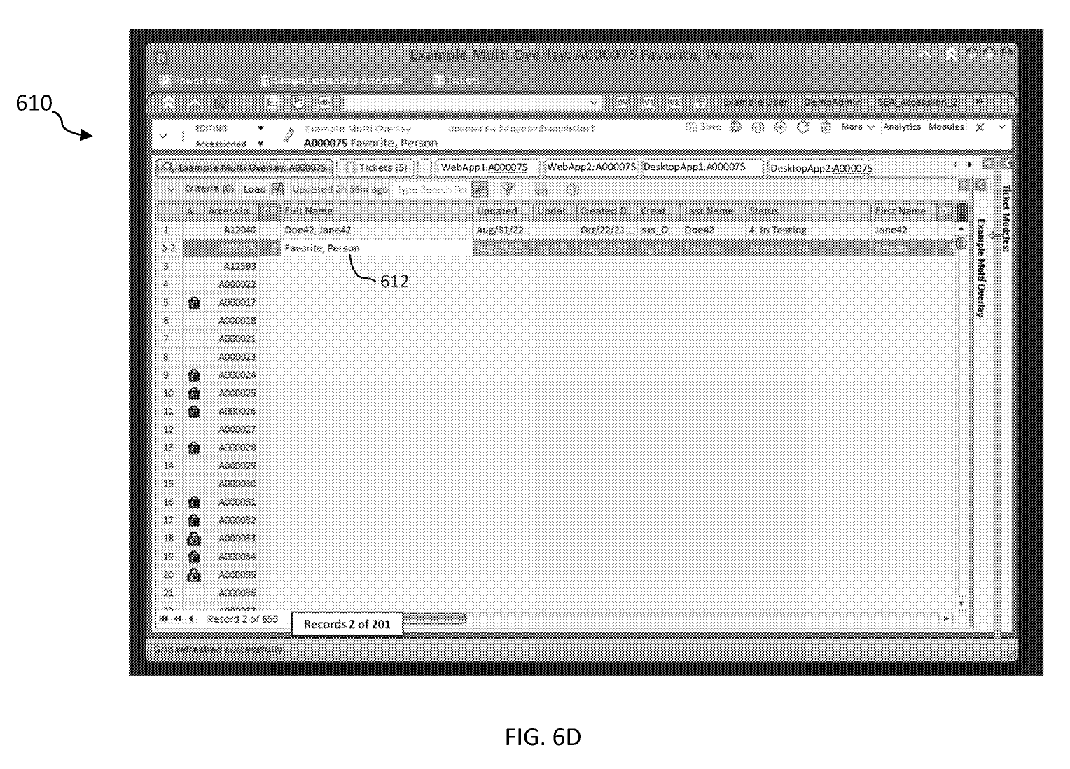

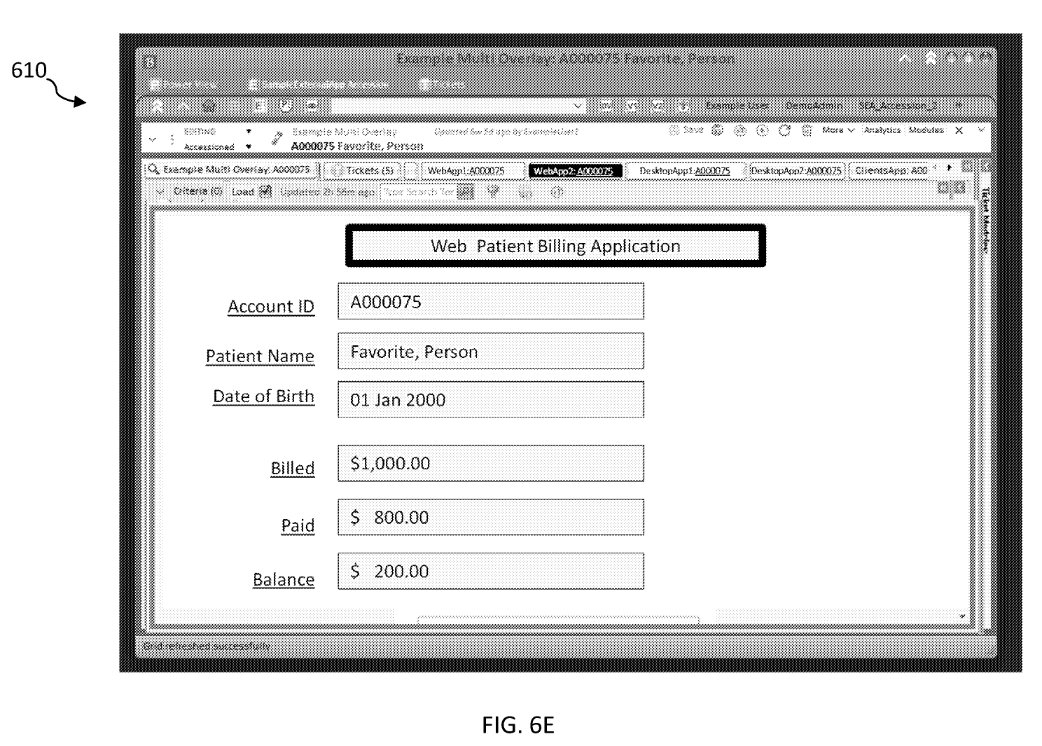

Referring to FIGS. 6A-6E, a process for application embedded graphical analytics driving application record interaction is provided and illustrated by graphical user interface600. In operation, the process may allow the user to select graphical analytic features and configure automatic extraction of record data into a grid and automatically open records in multiple different targeted applications. In one embodiment, a more detailed breakdown of the graphical data may be presented to the user by hovering a cursor over a portion of a graphical representation 602. Further, by right clicking on a specific portion 602 of the graph the user may elect to extract 604 record related to the selected portion 602 of the graph. This extracted data 606 may be shown in the dektop app 608 of multi-overlay window 610 of FIG. 6C. Further, the user may select a particular record of interest 612, as shown in multi-overlay window 610 of FIG. 6D) and then the user may open the patient file directly in the chosen application, here a patient billing file is opened in a web app 612 as shown in multi-overlay window 610 of FIG. 6E.

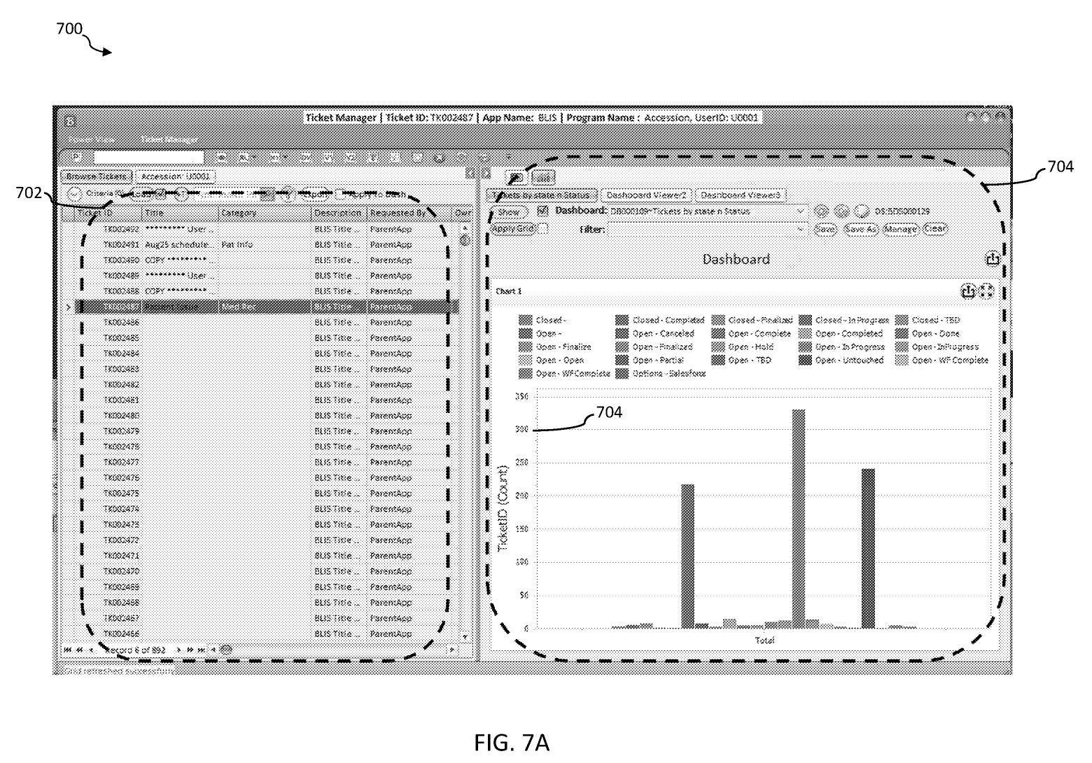

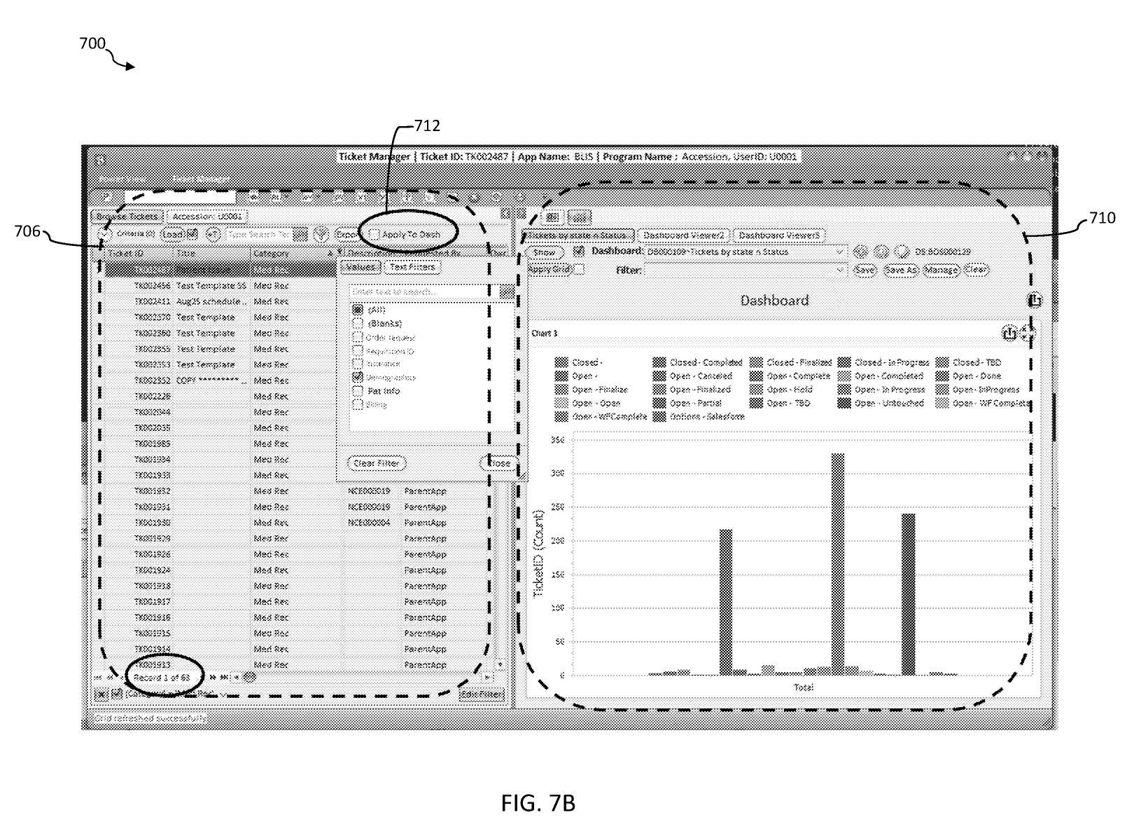

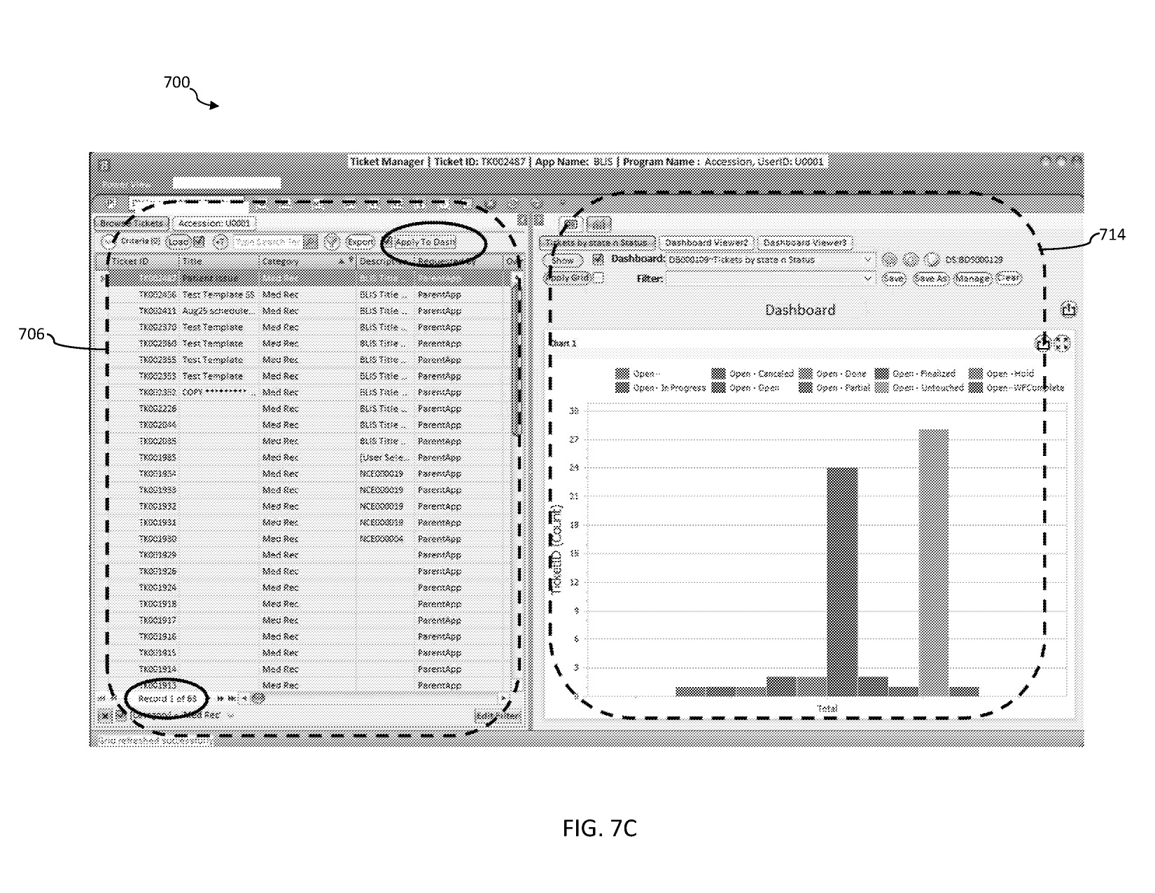

Referring to FIGS. 7A-7C, a process for graphical analytics 700 where a data source 702 may be changed in real time from a program data grid to any other table/database/source 704 is provided. As shown in the graphical analytics view 700 of FIG. 7A, the grid on the left portion 702 may not be the source of data for the graph on the right portion 704. FIG. 7B depicts a filter grid 706 of patient files filtered to only show medical records on the left, which only includes 63 records as highlighted by record count 708, while the graph continues to display a representation for all patient files, which includes hundreds of files in total . Here the graphical display 710 is different, because the “Apply to Dash” checkbox 712 has not been checked. FIG. 7C depicts the same filtered grid 706 of patient files alongside an updated graphical representation 714, because in this instance the “Apply to Dash” checkbox 712 has now been checked.

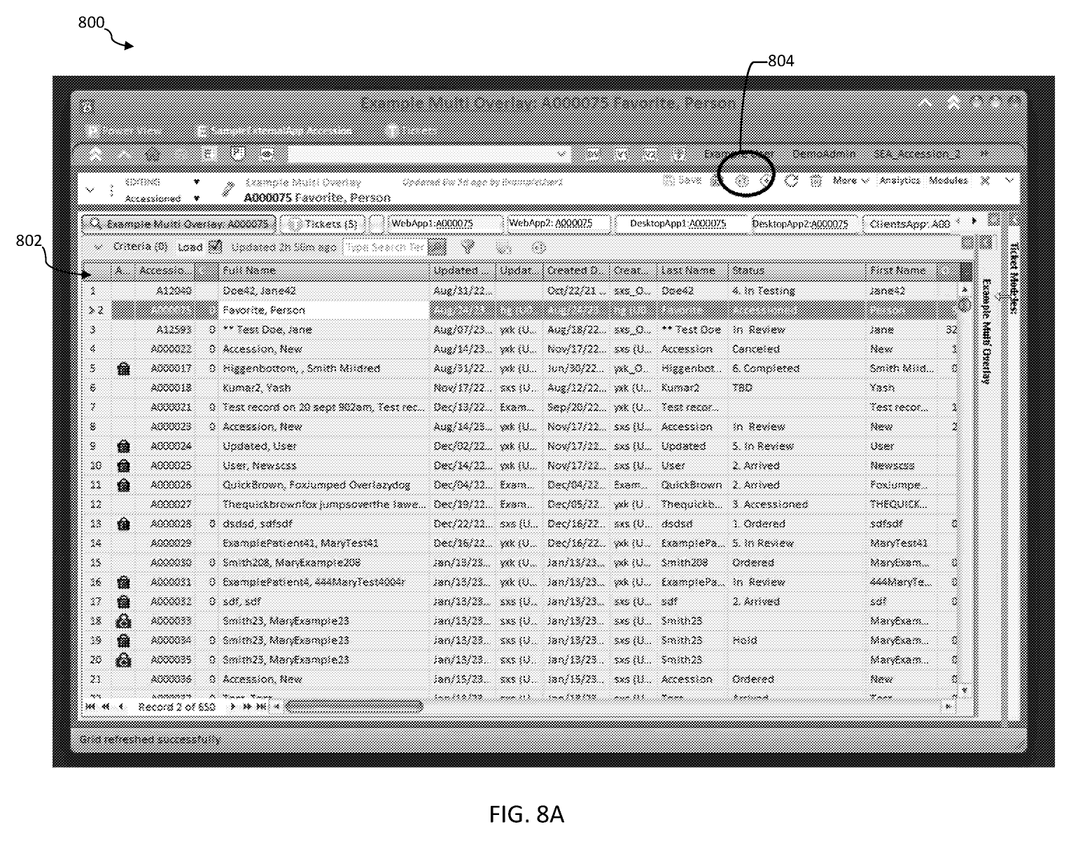

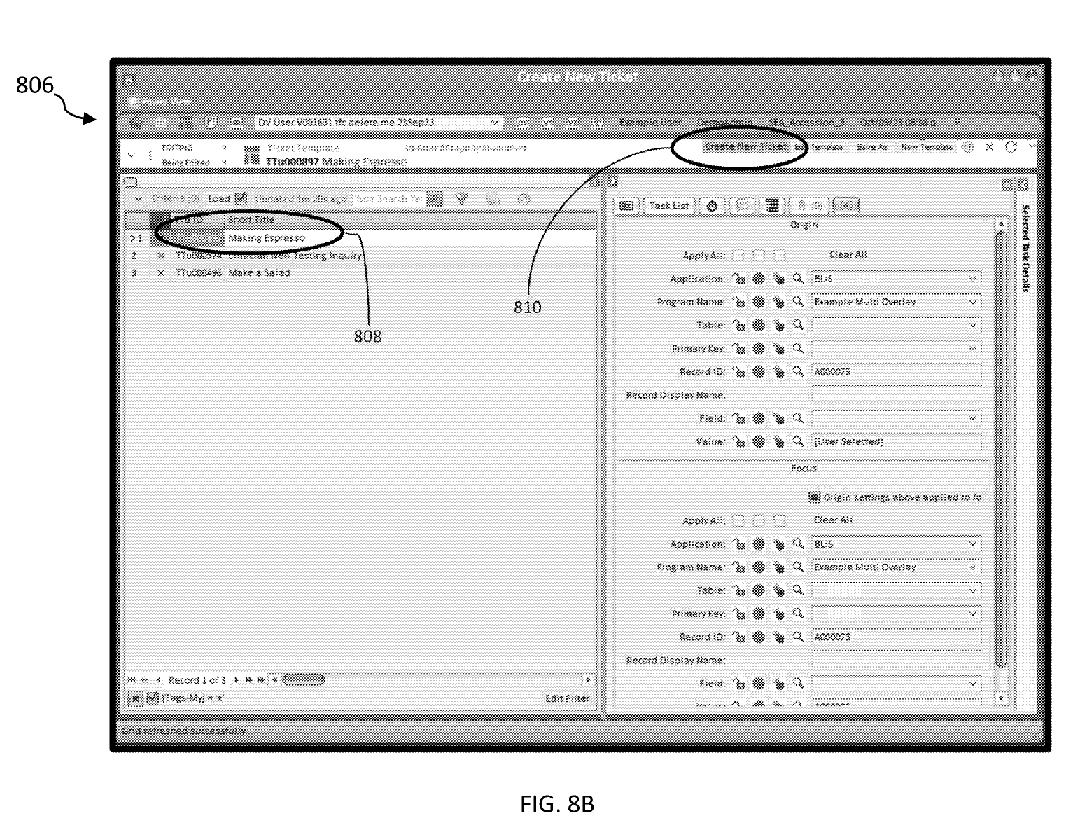

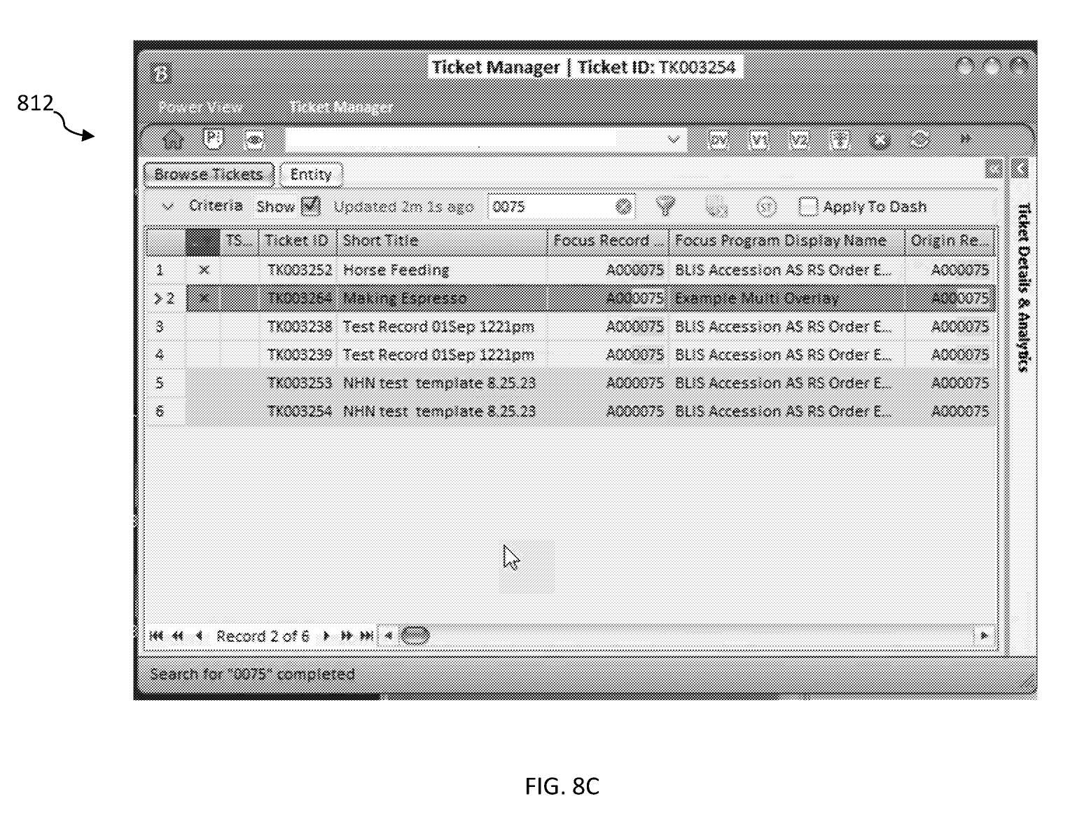

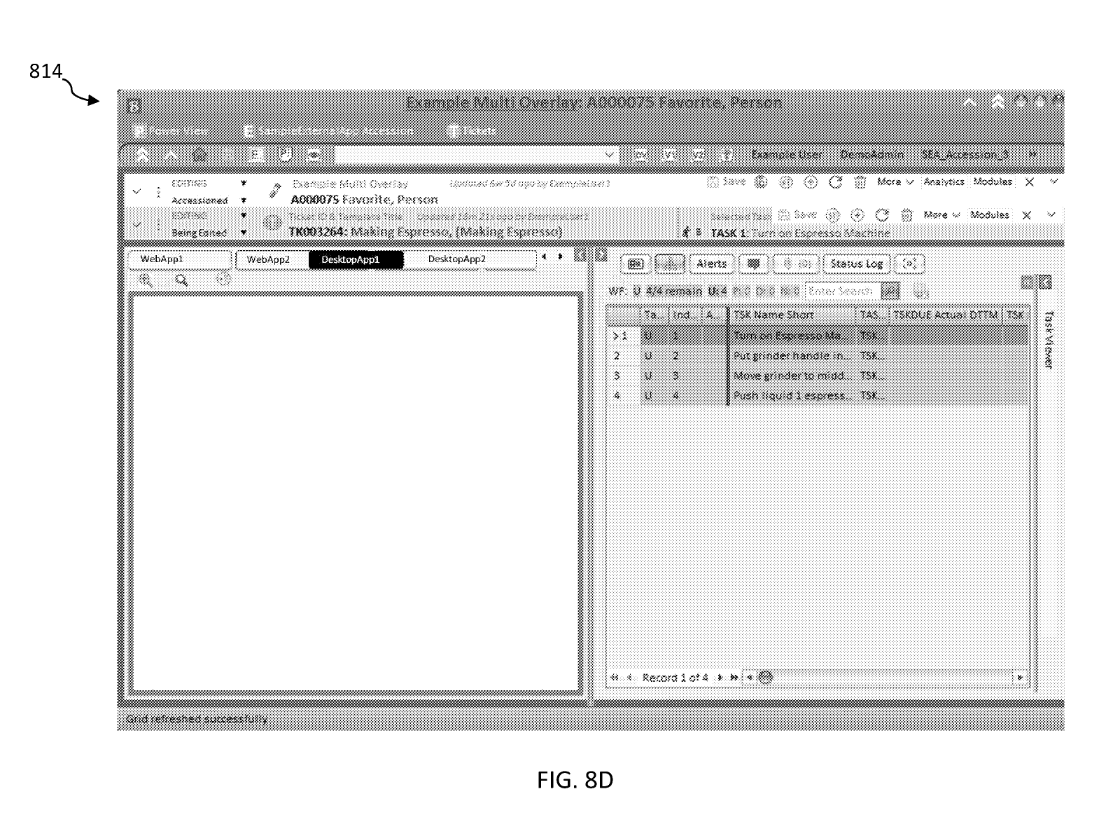

Referring now to FIGS. 8A-8D, embodiments depicting a modular overlay ticket system 800 (MOTS) is provided. MOTS 800 is an application that creates tickets which recognize and interacts with loaded records in external application(s) and can coordinate related processes between multiple external applications. Overlay window 802 shows a grid of patient data, but also includes a ticket template button 804 that ultimately allows a ticket to be created which automatically extracts from the loaded record information to identify the “origin” where ticket was created. Button 804 may sit on a grid of records or in form or above form.

In some embodiments, after clicking ticket template button 804, a ticket template selection screen 806 may open in a new window as shown in FIG. 8B. For example, when a user selects a ticket template 808 “Making Espresso” the focus and origin of this ticket will be the loaded record “A000075”. Configurable ticket templates have been created which identify the origin and focus of the ticket. Depending upon which configurable ticket template is chosen, the “focus” of the ticket can also include extracted information from the loaded record associated with the +T button. The focus information will target which program the newly created ticket will load and which record should be loaded in the overlay shell. If the user then clicks the “Create Ticket” button 810, then a new Ticket TK003264 is created with focus and origin record A000075 as shown in the ticket manager window 812 of FIG. 8C. The Focus program is “Example Multi Overlay” which determines which program will be opened in an overlay when the ticket is opened. By clicking on a ticket of interest a new multi overlay window 814 opens such that an external desktop application or web application can be opened alongside the tasks related to the newly created ticket, as shown in FIG. 8D.

Ticket systems either do not interact with external applications or require an integration to create automatic linkages between tickets and records in external system. The MOTS (modular overlay ticket system) is able to identify automatically which record within an external application a ticket originated from and also which record the tickets is focused upon.

For example, an external medical record system EMRABC may have a patient, identified as medical record “MR12345”, and the MOTs creates at ticket originating from the patient record which is focused upon a questionable test result record “TR789” generated from LabInfoSystem LISXYZ. Ticket is automatically created with Origin=MR12345 in application EMRABC, with a focus=TR789 in application LISXYZ. User may click on the ticket which then opens record TR789 within the LISXYZ within the MOTs overlay allow User to perform necessary work on ticket. Configuration is possible to change which record IDs get automatically identified as origin and focus. These tickets then have linkable functional modules such as workflows, analytics and communications.

In some embodiments, a ticket maybe created which recognizes and interacts with loaded records in external application(s) and can coordinate related processes between multiple external applications. In some embodiments, a computing device having Microsoft Windows 10 OS, .Net framework 4.7.2, Microsoft Visual Studio IDE (2019), and DevExpress Controls may be provided. Controls configured to: create a windows form, add a +T button, and add origin and target details to this +T button 804. Further upon clicking the +T button, the controls may load a ticket template form. On ticket template form select a ticket template record (see FIG. 8A). After selecting a ticket template record, there is a create ticket button 810 as well see FIG. 8B that may be used to create a ticket.

It will be apparent to those skilled in the art that various modifications and variations can be made in the current estimation scheme and debugging process of embodiments of the present disclosure without departing from the spirit or scope of the invention. Thus, it is intended that embodiments of the present disclosure cover the modifications and variations of this invention provided they come within the scope of the appended claims and their equivalents.

What is claimed is:

1. A computer-implemented method comprising:
allowing a user in one application to open and control a layout of both a web application and a desktop application;
allowing the web application and the desktop application to load and run in a native state;
allowing the user to direct which records are loaded by the web application and the desktop application; and
allowing the user to control a window position and layout of both the web application and the desktop application.

2. The computer-implemented method of claim 1, further comprising:
allowing a user to select one or more graphical analytic features and configure automatic extraction of record data into a grid; and
automatically opening records in multiple different targeted applications.

3. The computer-implemented method of claim 1, further comprising:
displaying graphical analytics at a graphical user interface; and
allowing a data source to be changed in real time from a program data grid to any other table/database/source.

4. The computer-implemented method of claim 3, wherein hovering a cursor over a section of a first graphical representation of data provides more detailed information about that section of the first graphical representation.

5. The computer-implemented method of claim 3, wherein right clicking a grid of patient data allows for the grid of patient data to be filtered based on pre-defined data categories.

6. The computer-implemented method of claim 5, wherein the pre-defined data categories are user defined.

7. The computer-implemented method of claim 3, wherein checking an “Apply to Dash” checkbox updates the first graphical representation to show a second graphical representation of the filtered data.

8. The computer-implemented method of claim 1, wherein both the web application and desktop application include a modular overlay ticketing system (MOTS) configured to create a ticket which automatically extracts from a source of patient record information.

9. The computer-implemented method of claim 7, wherein the MOTS includes a ticket template button configured to open a template selection screen.

10. The computer-implemented method of claim 8, wherein the template selection screen includes a ticket creation button configured to open a ticket manager window and allow for user creation of a new ticket that is automatically associated with a pre-loaded record for a selected patient.

11. The computer-implemented method of claim 9, wherein the ticket manager window is configured to open an external desktop application in a multi-overlay window.

12. A computer-readable storage medium having stored thereon instructions, which when executed by a processor result in the following operations:
allowing a user in one application to open and control a layout of both a web application and a desktop application;
allowing the web application and the desktop application to load and run in a native state;
allowing the user to direct which records are loaded by the web application and the desktop application; and
allowing the user to control a window position/layout of both the web application and the desktop application.

13. The computer-readable storage medium of claim 12, wherein further instructions, to be executed by the processor result in the following operations:
allowing a user to select one or more graphical analytic features and configure automatic extraction of record data into a grid; and
automatically opening records in multiple different targeted applications.

14. The computer-readable storage medium of claim 12, wherein further instructions, to be executed by the processor result in the following operations:
displaying graphical analytics at a graphical user interface; and
allowing a data source to be changed in real time from a program data grid to any other table/database/source.

15. The computer-readable storage medium of claim 14, wherein hovering a cursor over a section of a first graphical representation of data provides more detailed information about that section of the first graphical representation.

16. The computer-readable storage medium of claim 14, wherein right clicking a grid of patient data allows for the grid of patient data to be filtered based on pre-defined data categories.

17. The computer-readable storage medium of claim 16, wherein the pre-defined data categories are user defined.

18. The computer-readable storage medium of claim 14, wherein checking an “Apply to Dash” checkbox updates the first graphical representation to show a second graphical representation of the filtered data.

19. The computer-readable storage medium of claim 12, wherein both the web application and desktop application include a modular overlay ticketing system (MOTS) configured to create a ticket which automatically extracts from a source of patient record information.

20. The computer-readable storage medium of claim 19, wherein the MOTS includes a ticket template button configured to open a template selection screen.
